(19) United States
(12) Patent Application Publication
(10) Pub. No.: US 2025/0031759 A1
(43) Pub. Date: Jan. 30, 2025

(54) HEATING STRUCTURE AND AEROSOL GENERATING DEVICE INCLUDING THE SAME

(71) Applicant: KT&G CORPORATION, Daejeon (KR)

(72) Inventors: Wonkyeong LEE, Guri-si (KR); Paul Joon SUNWOO, Seoul (KR)

(73) Assignee: KT&G CORPORATION, Daejeon (KR)

(21) Appl. No.: 18/275,530

(22) PCT Filed: May 4, 2023
(86) PCT No.: PCT/KR2023/006092

§ 371 Date: Aug. 2, 2023

(30) Foreign Application Priority Data
May 18, 2022 (KR) 10-2022-0061020

(51) Int. Cl. A24F 40/46; A24F 40/50

(52) U.S. Cl. CPC A24F 40/46; A24F 40/50

(57) ABSTRACT

A heating structure configured to generate heat using surface plasmon resonance (SPR) includes a foam, wherein the foam may include a plurality of metal particles configured to generate heat by SPR, and a plurality of pores between the plurality of metal particles.

### TECHNICAL FIELD

The disclosure relates to a heating structure configured to generate heat by surface plasmon resonance (SPR), for example, an aerosol generating device including the heating structure.

### BACKGROUND ART

Techniques for heating a target by generating heat are being developed. For example, heat may be generated by supplying electrical energy to an electrically resistive element. As another example, heat may be generated by electromagnetic coupling between a coil and a susceptor. The above description is information the inventor(s) acquired during the course of conceiving the present disclosure, or already possessed at the time, and is not necessarily art publicly known before the present application was filed.

### DISCLOSURE OF THE INVENTION

### Technical Goals

One aspect of the present disclosure may provide a heating structure for generating heat using surface plasmon resonance (SPR) and an aerosol generating device including the same.

### Technical Solutions

A heating structure includes a foam, wherein the foam may include a plurality of metal particles configured to generate heat by surface plasmon resonance (SPR), and a plurality of pores between the plurality of metal particles.

The foam may include a substrate including the plurality of metal particles and the plurality of pores.

The substrate and the plurality of metal particles may be formed of different materials.

The plurality of metal particles may include nanoscale particles.

The foam may include a pervious area through which light passes between the plurality of pores.

At least some of the plurality of pores may be in fluid communication.

At least a portion of the plurality of pores may be open to an outside of the foam.

The heating structure may further include a reflecting body disposed on the foam and configured to reflect light toward the foam.

The reflecting body may be disposed along at least a portion of a periphery area of the foam.

The foam may further include a cavity.

The foam may further include a piercing member.

An aerosol generating device includes a light source, and a heating structure configured to receive light from the light source, wherein the heating structure may include a foam, wherein the foam may include a plurality of metal particles configured to generate heat by SPR, and a plurality of pores between the plurality of metal particles.

The light source may be configured to emit light having a wavelength of about 380 nanometers (nm) or greater.

The light source may include a plurality of light sources configured to emit light respectively toward different sides of the foam.

An aerosol generating system includes an aerosol generating article, and an aerosol generating device configured to generate an aerosol from the aerosol generating article, wherein the aerosol generating device may include a light source, and a heating structure configured to receive light from the light source, wherein the heating structure may include a foam, wherein the foam may include a plurality of metal particles configured to generate heat by SPR, and a plurality of pores between the plurality of metal particles.

### Effects

According to an embodiment, when a heating structure is applied to heat target(s), a target may be locally heated, or at least a portion of target(s) among a plurality of targets may be heated. According to an embodiment, the energy efficiency (e.g., battery efficiency) of a device to which a heating structure is applied (e.g., an aerosol generating device) may be improved. According to an embodiment, a substance may be generated from an article to which a heating structure is applied (e.g., an aerosol generating article) by vaporization rather than combustion by heat generated by the heating structure. The effects of the heating structure and the aerosol generating device including the same according to an embodiment may not be limited to the above-mentioned effects, and other unmentioned effects may be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIGS. 1 to 3 are diagrams illustrating examples of an aerosol generating article inserted into an aerosol generating device according to an embodiment.

FIGS. 4 and 5 are diagrams illustrating examples of an aerosol generating article according to an embodiment.

FIG. 6 is a block diagram of an aerosol generating device according to an embodiment.

FIG. 7 is a diagram illustrating a heating structure and an aerosol generating system including the same according to an embodiment.

FIG. 8 is an enlarged view of a portion A of the heating structure of FIG. 7 according to an embodiment.

FIG. 9 is a diagram illustrating a heating structure and an aerosol generating system including the heating structure according to an embodiment.

FIG. 10 is a diagram illustrating a heating structure and an aerosol generating system including the same according to an embodiment.

### MODE FOR CARRYING OUT THE INVENTION

The terms used in the embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, the present invention may be implemented in many different forms and is not limited to the embodiments described herein.

Hereinafter, embodiments of the disclosure will be described in detail with reference to the drawings.

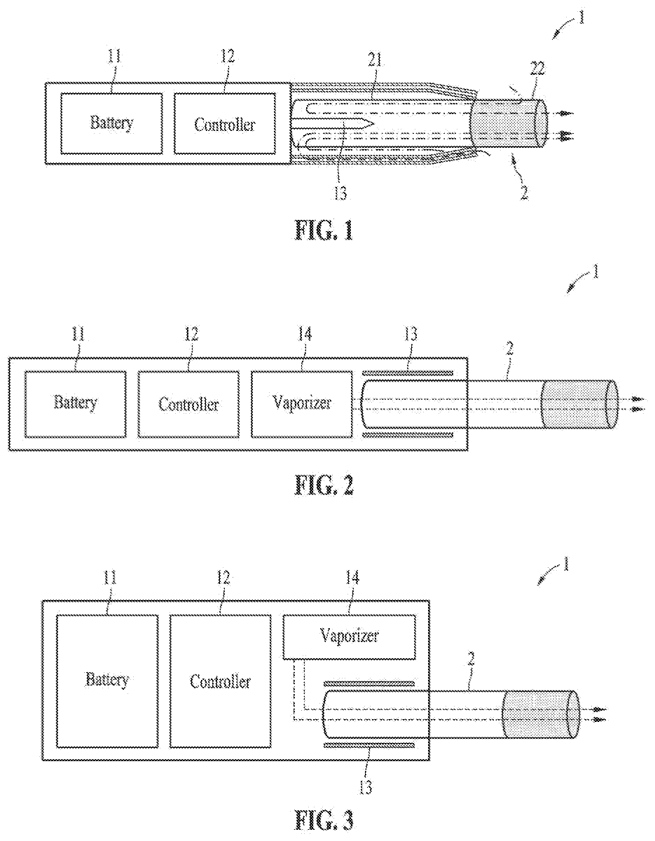

FIGS. 1 to 3 are diagrams illustrating examples of an aerosol generating article inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. In addition, an aerosol generating article 2 (e.g., a cigarette) may be inserted into an inner space of the aerosol generating device 1.

The aerosol generating device 1 shown in FIGS. 1 to 3 may include components related to an embodiment described herein. Therefore, it is to be understood by one of ordinary skill in the art to which the disclosure pertains that the aerosol generating device 1 may further include other general-purpose components in addition to the ones shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into the user.

Even when the aerosol generating article 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The at least one processor may be implemented as an array of a plurality of logic gates, or may be implemented as a combination of a general-purpose microprocessor and a memory in which a program executable by the microprocessor is stored. In addition, it is to be understood by those having ordinary skill in the art to which the disclosure pertains that the at least one processor may be implemented in other types of hardware.

The heater 13 may be heated by the power supplied by the battery 11. For example, when an aerosol generating article is inserted in the aerosol generating device 1, the heater 13 may be disposed outside the aerosol generating article. The heated heater 13 may thus raise the temperature of an aerosol generating material in the aerosol generating article.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

For another example, the heater 13 may be an induction heater. Specifically, the heater 13 may include an electrically conductive coil for heating the aerosol generating article in an induction heating manner, and the aerosol generating article may include a susceptor to be heated by the induction heater.

For example, the heater 13 may include a tubular heating element, a plate-shaped heating element, a needle-shaped heating element, or a rod-shaped heating element, and may heat the inside or outside of the aerosol generating article 2 according to the shape of a heating element.

In addition, the heater 13 may be provided as a plurality of heaters in the aerosol generating device 1. In this case, the plurality of heaters 13 may be disposed to be inserted into the aerosol generating article 2 or may be disposed outside the aerosol generating article 2. In addition, some of the plurality of heaters 13 may be disposed to be inserted into the aerosol generating article 2, and the rest may be disposed outside the aerosol generating article 2. However, the shape of the heater 13 is not limited to what is shown in FIGS. 1 through 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the aerosol generating article into the user.

For example, the vaporizer 14 may include a liquid storage (e.g., a reservoir), a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. The liquid composition may also include an aerosol former such as glycerin and propylene glycol.

The liquid transfer means may transfer the liquid composition in the liquid storage to the heating structure. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

Meanwhile, the aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, an aerosol generating article insertion detection sensor, etc.). In addition, the aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter or the like. Alternatively, the second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the aerosol generating article 2 through at least one hole formed on a surface of the aerosol generating article 2.

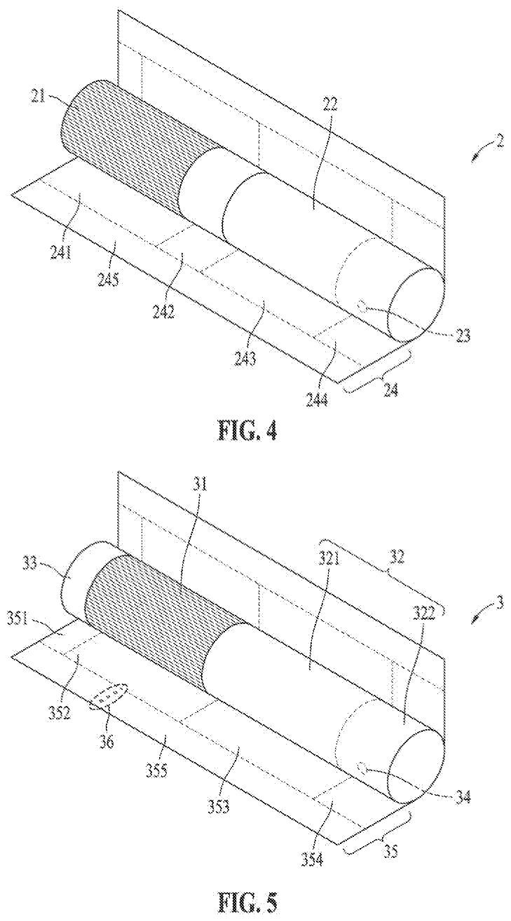

Hereinafter, examples of the aerosol generating article 2 will be described with reference to FIGS. 4 and 5.

FIGS. 4 and 5 are diagrams illustrating examples of an aerosol generating article.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, alternatively, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

The diameter of the aerosol generating article 2 may be in a range of 5 mm to 9 mm, and the length thereof may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more of wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, the basis weight of the third wrapper 243 may be in a range of 88 g/m² to 96 g/m², and may be desirably in a range of 90 g/m² to 94 g/m². In addition, the thickness of the third wrapper 243 may be in a range of 120 μm to 130 μm, and may be desirably about 125 μm.

The fourth wrapper 244 may be formed of oilproof hard wrapping paper. For example, the basis weight of the fourth wrapper 244 may be in a range of 88 g/m² to 96 g/m², and may be desirably in a range of 90 g/m² to 94 g/m². In addition, the thickness of the fourth wrapper 244 may be in a range of 120 μm to 130 μm, and may be desirably about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of 57 g/m² to 63 g/m², and may be desirably 60 g/m². In addition, the thickness of the fifth wrapper 245 may be in a range of 64 μm to 70 μm, and may be desirably about 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

In addition, the fifth wrapper 245 may prevent an aerosol generating device (e.g., holder) from being contaminated by substances produced in the aerosol generating article 2. Liquid substances may be produced in the aerosol generating article 2 when a user puffs. For example, as an aerosol generated in the aerosol generating article 2 is cooled by external air, such liquid substances (e.g., moisture, etc.) may be produced. As the aerosol generating article 2 is wrapped with the fifth wrapper 245, the liquid substances generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, a metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. As another example, the second segment may be manufactured by weaving a separate fiber to which a flavoring liquid is applied and the fiber formed of the polymer together. As still another example, the second segment may be formed with a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA,) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. In addition, the total surface area of the second segment may be between about 300 mm²/mm and about 1000 mm²/mm. Further, an aerosol cooling element may be formed from a material having a specific surface area between about 10 mm²/mg and about 100 mm²/mg.

Meanwhile, the second segment may include a thread containing a volatile flavor ingredient. The volatile flavor ingredient may be menthol. However, embodiments are not limited thereto. For example, the thread may be filled with a sufficient amount of menthol to provide at least 1.5 mg of menthol to the second segment.

A third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the aerosol generating article 3 may correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The aerosol generating article 3 may be wrapped by at least one wrapper 35. The wrapper 35 may have at least one hole through which external air flows inside or internal gas flows outside. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, the total thickness of the first wrapper 351 may be in a range of 45 μm to 55 μm, and may be desirably about 50.3 μm. Further, the thickness of the metal foil of the first wrapper 351 may be in a range of 6 μm to 7 μm, and may be desirably 6.3 μm. In addition, the basis weight of the first wrapper 351 may be in a range of 50 g/m² to 55 g/m², and may be desirably 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, the thickness of the second wrapper 352 may be in a range of 70 μm to 80 μm, and may be desirably about 78 μm. In addition, the basis weight of the second wrapper 352 may be in a range of 20 g/m² to 25 g/m², and may be desirably 23.5 g/m².

For example, the porosity of the third wrapper 353 may be 24000 CU. However, embodiments are not limited thereto. Further, the thickness of the third wrapper 353 may be in a range of 60 μm to 70 μm, and may be desirably about 68 μm. In addition, the basis weight of the third wrapper 353 may be in a range of 20 g/m² to 25 g/m², and may be desirably 21 g/m².

The fourth wrapper 354 may be formed with polylactic acid (PLA) laminated paper. Here, the PLA laminated paper may refer to three-ply paper including a paper layer, a PLA layer, and a paper layer. For example, the thickness of the fourth wrapper 354 may be in a range of 100 μm to 120 μm, and may be desirably about 110 μm. In addition, the basis weight of the fourth wrapper 354 may be in a range of 80 g/m² to 100 g/m², and may be desirably 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 355 may be in a range of 57 g/m² to 63 g/m², and may be desirably about 60 g/m². Further, the thickness of the fifth wrapper 355 may be in a range of 64 μm to 70 μm, and may be desirably about 67 μm.

The fifth wrapper 355 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. The mono denier of a filament of the cellulose acetate tow may be in a range of 1.0 to 10.0, and may be desirably in a range of 4.0 to 6.0. The mono denier of the filament of the front end plug 33 may be more desirably about 5.0. In addition, a cross section of the filament of the front end plug 33 may be Y-shaped. The total denier of the front end plug 33 may be in a range of 20000 to 30000, and may be desirably in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, the mono denier and the total denier of the first segment 321 may be the same as the mono denier and the total denier of the front end plug 33.

The second segment 322 may be formed of cellulose acetate. The mono denier of a filament of the second segment 322 may be in a range of 1.0 to 10.0, and may be desirably in a range of 8.0 to 10.0. The mono denier of the filament of the second segment 322 may be more desirably 9.0. In addition, a cross section of the filament of the second segment 322 may be Y-shaped. The total denier of the second segment 322 may be in a range of 20000 to 30000, and may be desirably 25000.

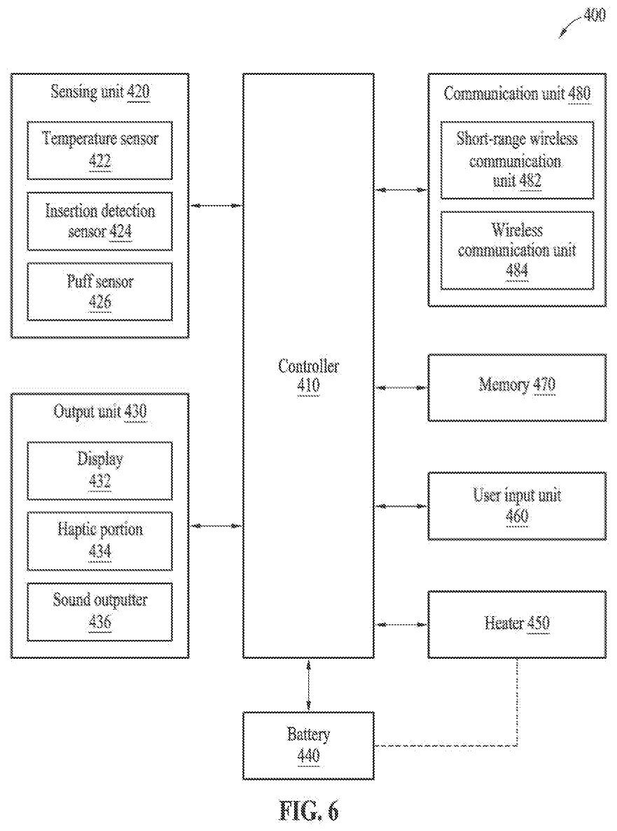

FIG. 6 is a block diagram of an aerosol generating device 400 according to an embodiment. The aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 to 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, that converts power of the battery 440 and supplies the power to respective components.

In an embodiment, the heater 450 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating element, or the like, but is not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed thereby. The memory 470 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communicator, an Internet communicator, a computer network (e.g., a local area network (LAN) or a wide-area network (WAN)) communicator, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The at least one processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

One embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

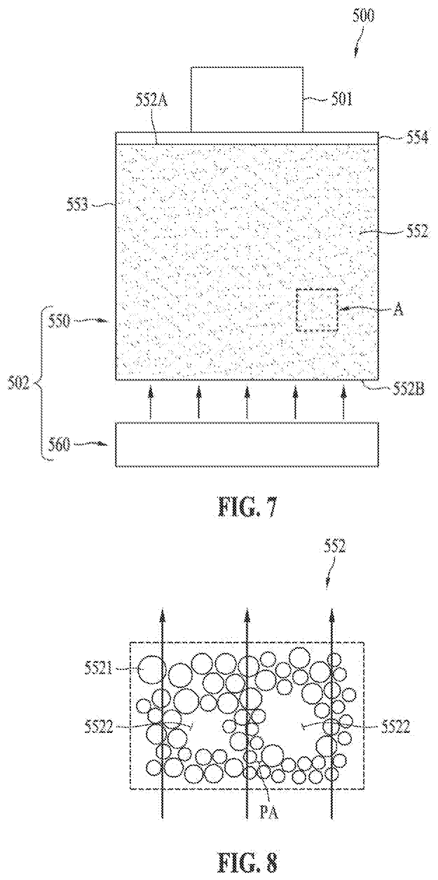

FIG. 7 is a diagram illustrating a heating structure and an aerosol generating system including the same according to an embodiment, and FIG. 8 is an enlarged view of a portion A of the heating structure of FIG. 7 according to an embodiment.

Referring to FIGS. 7 and 8, an aerosol generating system 500 may include an aerosol generating article 501 containing a vaporizable substance, and an aerosol generating device 502 configured to generate an aerosol from the aerosol generating article 501.

The aerosol generating device 502 may include a heating structure 550. The heating structure 550 may be configured to generate heat by surface plasmon resonance (SPR). The term “SPR” refers to the collective oscillation of electrons propagating along an interface of metal particles with a medium. For example, the collective oscillation of electrons of metal particles may be caused by light hitting the heating structure 550. The excitation of electrons of metal particles may generate thermal energy, and the generated thermal energy may be transferred within an environment where the heating structure 550 is present. In an embodiment, the heating structure 550 may be configured to heat another target (e.g., the aerosol generating article 501) by transferring the generated heat to the target.

In an embodiment, the heating structure 550 may be configured to heat the target (e.g., the aerosol generating article 501) to any suitable temperature. For example, the heating structure 550 may be configured to heat the target to a temperature of about 200° C. to about 350° C. or less. If the heating structure 550 uses SPR, the size of an energy source (e.g., a battery) supplied to the aerosol generating device 502 may be reduced.

In an embodiment, the heating structure 550 may include a foam 552. The foam 552 may include a first surface 552A (e.g., a top surface in FIG. 7) and a second surface 552B (e.g., a bottom surface in FIG. 7) opposite to the first surface 552A.

In an embodiment, the aerosol generating article 501 may be disposed on the first surface 552A of the foam 552. For example, the aerosol generating article 501 may be apart from the first surface 552A. Alternatively, the aerosol generating article 501 may substantially contact the first surface 552A.

In an embodiment, the foam 552 may include a plurality of metal particles 5521. The plurality of metal particles 5521 may include any material suitable for generating heat by SPR. For example, the plurality of metal particles 5521 may include at least one of gold, silver, copper, palladium, platinum, aluminum, titanium, nickel, chromium, iron, cobalt, manganese, rhodium, and ruthenium, or a combination thereof.

In an embodiment, the plurality of metal particles 5521 may be formed of any material suitable for generating heat by interacting with light of a determined wavelength band (e.g., a visible light wavelength band, that is, about 380 nm to about 780 nm). For example, the plurality of metal particles may include at least one of gold, silver, copper, palladium, and platinum, or a combination thereof.

In an embodiment, the plurality of metal particles 5521 may be nanoscale. For example, the plurality of metal particles 5521 may have an average maximum diameter of about 1 μm or less. In some embodiments, the plurality of metal particles 5521 may have an average maximum diameter of about 700 nm or less, about 600 nm or less, about 500 nm or less, about 400 nm or less, about 300 nm or less, about 200 nm or less, about 150 nm or less, or about 100 nm or less.

In an embodiment, the plurality of metal particles 5521 may be formed of a metal material having an average maximum absorbance. Here, the average maximum absorbance may be defined as an absorbance substantially having a peak in a specific wavelength band. The specific wavelength band corresponding to the absorbance may be understood as a wavelength band in which the plurality of metal particles 5521 resonate. For example, the plurality of metal particles 5521 may be formed of a metal material having an average maximum absorbance in a wavelength band between about 430 nm and about 450 nm, between about 480 nm and about 500 nm, between about 490 nm and about 510 nm, between about 500 nm and about 520 nm, between about 550 nm and about 570 nm, between about 600 nm and about 620 nm, between about 620 nm and about 640 nm, between about 630 nm and about 650 nm, between about 640 nm and about 660 nm, between about 680 nm and about 700 nm, or between about 700 nm and about 750 nm.

In an embodiment, the plurality of metal particles 5521 may form a substrate 553. Here, forming the substrate 553 indicates that the plurality of metal particles 5521 are arranged to form the shape of the substrate 553. The substrate 553 may have the first surface 552A and the second surface 552B of the foam 552.

In an embodiment, the foam 552 may include a plurality of pores 5522. The plurality of pores 5522 may allow air to pass therethrough. For example, air may flow from the second surface 552B of the foam 552 through the plurality of pores 5522 to the first surface 552A of the foam 552. Air may pass through the aerosol generating article 501 and deliver an aerosol to a user.

In an embodiment, the plurality of pores 5522 may be formed surrounded by the plurality of metal particles 5521. At least a portion of the plurality of pores 5522 may be open to the outside of the foam 552. Some of the plurality of pores 5522 may be in fluid communication with each other.

In an embodiment, the size of the plurality of pores 5522 may be substantially equal to or greater than the size of the plurality of metal particles 5521. For example, the plurality of pores 5522 may have an average maximum dimension (e.g., width or diameter) of about 1 μm or greater, about 5 μm or greater, about 10 μm or greater, about 20 μm or greater, about 30 μm or greater, about 50 μm or greater, or about 100 μm or greater. The plurality of pores 5522 may have an average maximum dimension (e.g., width or diameter) of about 200 μm or less, about 150 μm or less, about 100 μm or less, about 50 μm or less, or about 20 μm or less.

In an embodiment, the plurality of pores 5522 may be formed such that the foam 552 may have any porosity suitable for allowing air to pass therethrough. For example, the foam 552 may have a porosity of about 5 pores per inch (ppi) or greater, about 10 ppi or greater, about 20 ppi or greater, about 30 ppi or greater, about 50 ppi or greater, about 100 ppi or greater, about 200 ppi or greater, about 300 ppi or greater, about 500 ppi or greater, or about 700 ppi or greater. The foam 552 may have a porosity of about 5,000 ppi or less, about 4,000 ppi or less, about 3,000 ppi or less, about 2,000 ppi or less, about 1,000 ppi or less, about 500 ppi or less, about 300 ppi or less, about 150 ppi or less, about 120 ppi or less, or about 100 ppi or less.

In an embodiment, the foam 552 may include a pervious area PA through which light passes between the plurality of pores 5522. At least a portion of the plurality of metal particles 5521 may be disposed in the pervious area PA. While light passes through the pervious area PA, heat may be generated by SPR of the plurality of metal particles 5521, such that the entire foam 522 may be heated.

In an embodiment, the amount of heat transfer of the foam 552 may depend on the size and shape of the foam 552.

In an embodiment, the substrate 553 may be formed of a metal material different from that of the plurality of metal particles 5521. For example, the substrate 553 may be formed of stainless steel (e.g., SUS 314), aluminum, copper, and/or any other metal material.

In an embodiment, the substrate 553 may be formed of a material having any thermal conductivity suitable for use in an environment in which the heating structure 550 is disposed. For example, the substrate 553 may have a thermal conductivity of about 0.6 Watts per meter-Kelvin (W/mK) or less, about 1 W/mK to about 2 W/mK, about 2 W/mK to about 5 W/mK, about 5 W/mK to about 10 W/mK, about 10 W/mK to about 100 W/mK, or about 100 W/mK to about 200 W/mK, at a pressure of 1 bar and a temperature of 25° C. In some embodiments, the substrate 553 may have a thermal conductivity of about 0.6 W/mK or less, about 1.3 W/mK, about 148 W/mK, or about 46.06 W/mK, at a pressure of 1 bar and a temperature of 25° C.

In an embodiment, the substrate 553 may exhibit electrical conductivity. In an embodiment, the substrate 553 may exhibit electrical insulating properties.

In an embodiment, the heating structure 550 may include a reflecting body 554 configured to reflect light toward the foam 552. When the reflecting body 554 reflects the light passing through the foam 552 toward the foam 552, it may cause the plurality of metal particles 5521 to use the reflected light, thereby increasing the light use efficiency of the heating structure 550 and increasing heat efficiency accordingly.

In an embodiment, the reflecting body 554 may have a layer shape. The reflecting body 554 may extend along at least a portion of a periphery area (e.g., the first surface 552A) of the foam 552.

In an embodiment, the reflecting body 554 may be disposed on the first surface 552A of the foam 552. The reflecting body 554 may substantially contact the first surface 552A of the foam 552. In an embodiment, the reflecting body 554 may be formed on the entire first surface 552A of the foam 552. In an embodiment, the reflecting body 554 may be formed on a portion of the first surface 552A of the foam 552. For example, the reflecting body 554 may be implemented as a single reflective zone in a partial area of the first surface 552A of the foam 552, or as a plurality of reflective zones.

In an embodiment, the reflecting body 554 may be disposed between the aerosol generating article 501 and the foam 552. The reflecting body 554 may substantially contact the aerosol generating article 501.

In an embodiment, the reflecting body 554 may be formed of any material suitable for reflecting light (e.g., a metal material). For example, the reflecting body 554 may be formed of at least one of gold, silver, copper, and any other metal material suitable for reflection, or a combination thereof.

In an embodiment, the reflecting body 554 may have any thickness suitable for reflecting light. The thickness of the reflecting body 554 may be determined to be a value suitable for substantially total reflection of light. For example, the reflecting body 554 may have a thickness of about 15 nm or less, about 12 nm or less, about 10 nm or less, about 8 nm or less, or about 5 nm or less. In a preferred example, the reflecting body 554 may have a thickness of about 10 nm.

In an embodiment, the aerosol generating device 502 may include a light source 560. The light source 560 may be configured to emit light toward the second surface 552B of the foam 552.

In an embodiment, the light source 560 may be configured to emit light toward the heating structure 550 at a determined angle. For example, the light source 560 may emit light at an angle that may cause total reflection on the surface of the heating structure 550. In an embodiment, the light source 560 may emit light toward the heating structure 550 at any angle.

In an embodiment, the light source 560 may be configured to emit light in the visible band (e.g., about 380 nm to about 780 nm). For example, when the plurality of metal particles 5521 include gold, the light source 560 may emit light having a wavelength of about 600 nm to about 650 nm. When the plurality of metal particles 5521 include silver, the light source 560 may emit light having a wavelength of about 450 nm to about 550 nm. In an embodiment, the light source 560 may include an infrared heat source.

In an embodiment, the light source 560 may emit light at any suitable output power. For example, the light source 560 may emit light at an output power of about 900 mW.

In an embodiment, the light source 560 may include a light-emitting diode and/or a laser. The light-emitting diode and/or the laser may be of a type and/or size suitable for being included in the aerosol generating device 500. For example, the laser may include a solid-state laser and/or a semiconductor laser.

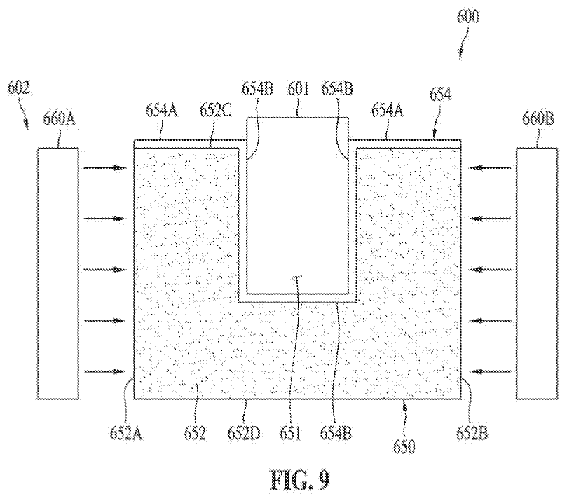

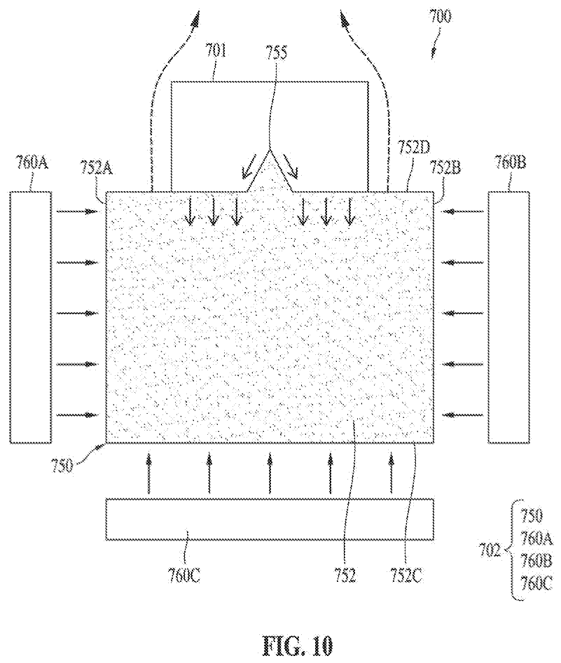

FIG. 9 is a diagram illustrating a heating structure and an aerosol generating system including the heating structure according to an embodiment.

Referring to FIG. 9, an aerosol generating system 600 may include an aerosol generating article 601 and an aerosol generating device 602. The aerosol generating device 602 may include a heating structure 650.

In an embodiment, the heating structure 650 may include a foam 652. The foam 652 may include a first surface 652A (e.g., a left side surface in FIG. 9), a second surface 652B (e.g., a right side surface in FIG. 9) opposite to the first surface 652A, a third surface 652C (e.g., an upper side surface in FIG. 9) between the first surface 652A and the second surface 652B, and a fourth surface 652D (e.g., a lower side surface in FIG. 9) opposite to the third surface 652C and between the first surface 652A and the second surface 652B.

In an embodiment, the foam 652 may include a cavity 651. The cavity 651 may be configured to at least partially receive the aerosol generating article 601. The cavity 651 may have a shape corresponding to an outer profile of the aerosol generating article 601. The cavity 651 may be implemented as a recess formed from the third surface 652C of the foam 652 toward the fourth surface 652D.

In an embodiment, the heating structure 650 may include a reflecting body 654. The reflecting body 654 may include a first reflecting body 654A disposed on the third surface 652C of the foam 652. The first reflecting body 654A may extend along at least a portion of a periphery area (e.g., the third surface 652C) of the foam 652. The first reflecting body 654A may substantially contact the third surface 652C of the foam 652. The first reflecting body 654A may be formed on the entire third surface 652C of the foam 652. The first reflecting body 654A may be formed on a portion of the third surface 652C of the foam 652.

In an embodiment, the reflecting body 654 may include a second reflecting body 654B disposed on an inner surface (e.g., a recessed surface) of the cavity 651 of the foam 652. The second reflecting body 654B may be disposed between the foam 652 and the aerosol generating article 601. The second reflecting body 654B may substantially contact the inner surface of the cavity 651. The second reflecting body 654B may be formed on the entire inner surface of the cavity 651. The second reflecting body 654B may be formed on a portion of the inner surface of the cavity 651.

In an embodiment, the first reflecting body 654A and the second reflecting body 654B may be connected to each other. For example, the first reflecting body 654A and the second reflecting body 654B may be integrally and seamlessly connected. In an embodiment, the first reflecting body 654A and the second reflecting body 654B may be physically separated from each other.

In an embodiment, the aerosol generating device 600 may include a plurality of light sources 660A and 660B. The plurality of light sources 660A and 660B may be implemented as light sources of the same type. Alternatively, at least a portion of the plurality of light sources 660A and 660B may be implemented as different types of light sources. In an embodiment, the aerosol generating device 600 may include a single light source 660A or 660B.

In an embodiment, the plurality of light sources 660A and 660B may include a first light source 660A configured to emit light toward the first surface 652A of the foam 652, and a second light source 660B configured to emit light toward the second surface 652B of the foam 652. The first light source 660A and the second light source 660B may be disposed on opposite sides of the foam 652. The first light source 660A may be apart from the first surface 652A of the foam 652. The second light source 660B may be apart from the second surface 652B of the foam 652.

In an embodiment, at least one light source 660A or 660B among the plurality of light sources 660A and 660B may be configured to illuminate a portion of the heating structure 650.

In an embodiment, the plurality of light sources 660A and 660B may be configured to emit light substantially at the same time. In an embodiment, the plurality of light sources 660A and 660B may emit light at different times.

In an embodiment, the plurality of light sources 660A and 660B may illuminate the heating structure 650 for substantially the same period of time. In an embodiment, the length of illumination time of the plurality of light sources 660A and 660B may be different from each other.

In an embodiment, the plurality of light sources 660A and 660B may emit light of substantially the same wavelength band. In an embodiment, the plurality of light sources 660A and 660B may emit light of different wavelength bands.

In an embodiment, the plurality of light sources 660A and 660B may illuminate the heating structure 650 with substantially the same illuminance. In an embodiment, the plurality of light sources 660A and 660B may emit light having different illuminance.

FIG. 10 is a diagram illustrating a heating structure and an aerosol generating system including the same according to an embodiment.

Referring to FIG. 10, an aerosol generating system 700 may include an aerosol generating article 701 and an aerosol generating device 702.

In an embodiment, the aerosol generating article 701 may include a component (e.g., a cartridge) that is removable from the aerosol generating device 702 and insertable into the aerosol generating device 702. The aerosol generating article 701 may include a liquid composition.

The aerosol generating device 702 may include a heating structure 750. The heating structure 750 may include a foam 752. The foam 752 may include a first surface 752A (e.g., a left side surface in FIG. 10), a second surface 752B (e.g., a right side surface in FIG. 10) opposite to the first surface 752A, a third surface 752C (e.g., a lower side surface in FIG. 10) between the first surface 752A and the second surface 752B, and a fourth surface 752D (e.g., an upper side surface in FIG. 10) opposite to the third surface 752C and between the first surface 752A and the second surface 752B.

The foam 752 may be disposed within the aerosol generating device 702 such that the fourth surface 752D may face a mouth end portion of the aerosol generating device 702 through which an aerosol is delivered to the user's mouth.

The aerosol generating article 701 may be disposed on the fourth surface 752D of the foam 752. For example, the aerosol generating article 701 may substantially contact the fourth surface 752D of the foam 752.

In an embodiment, the foam 752 may include a piercing member 755. The piercing member 755 may be configured to pierce at least a portion of the aerosol generating article 701 when the aerosol generating article 701 is disposed on the fourth surface 752D of the foam 752. When the piercing member 755 pierces the aerosol generating article 701, a vaporizable substance (e.g., a liquid composition) within the aerosol generating article 701 may flow into the foam 752 along an outer surface of the piercing member 755 and/or through the fourth surface 752D of the foam 752. The vaporizable substance may be heated in the foam 752 and undergo a phase change to an aerosol, and the aerosol may move in a direction away from the fourth surface 752D of the foam 752 and be delivered to a user through the mouth end portion (not shown) of the aerosol generating device 702.

In an embodiment, the aerosol generating device 702 may include at least one light source 760A, 760B, and 760C. For example, the aerosol generating device 702 may include a first light source 760A disposed to emit light toward the first surface 752A of the foam 752, a second light source 760B disposed to emit light toward the second surface 752B of the foam 752, and a third light source 760C disposed to emit light toward the third surface 752C of the foam 752. The first light source 760A may be apart from the first surface 752A. The second light source 760B may be apart from the second surface 752B. The third light source 760C may be apart from the third surface 752C. Meanwhile, unlike the drawing, the aerosol generating device 702 may include a single light source, two light sources, or four or more light sources.

The embodiments of the present disclosure are intended to be illustrative and not restrictive. Various modifications may be made to the detailed description of the present disclosure including the accompanying scope of claims and equivalents. Any of the embodiment(s) described herein may be used in combination with any other embodiment(s) described herein.

1. A heating structure, comprising:
a foam,
wherein the foam comprises:
a plurality of metal particles configured to generate heat by surface plasmon resonance (SPR); and
a plurality of pores between the plurality of metal particles.

2. The heating structure of claim 1, wherein
the foam comprises a substrate comprising the plurality of metal particles and the plurality of pores.

3. The heating structure of claim 2, wherein
the substrate and the plurality of metal particles are formed of different materials.

4. The heating structure of claim 1, wherein
the plurality of metal particles comprise nanoscale particles.

5. The heating structure of claim 1, wherein
the foam comprises a pervious area through which light passes between the plurality of pores.

6. The heating structure of claim 1, wherein
at least some the plurality of pores are in fluid communication.

7. The heating structure of claim 1, wherein
at least a portion of the plurality of pores are open to an outside of the foam.

8. The heating structure of claim 1, further comprising:
a reflecting body disposed on the foam and configured to reflect light toward the foam.

9. The heating structure of claim 8, wherein
the reflecting body is disposed along at least a portion of a periphery area of the foam.

10. The heating structure of claim 1, wherein
the foam further comprises a cavity.

11. The heating structure of claim 1, wherein
the foam further comprises a piercing member.

12. An aerosol generating device, comprising:
a light source; and
the heating structure according to claim 1, which is configured to receive light from the light source.

13. The aerosol generating device of claim 12, wherein
the light source is configured to emit light having a wavelength of about 380 nanometers (nm) or greater.

14. The aerosol generating device of claim 12, wherein
the light source comprises a plurality of light sources configured to emit light respectively toward different sides of the foam.

15. An aerosol generating system, comprising:
an aerosol generating article; and
the aerosol generating device according to claim 12, which is configured to generate an aerosol from the aerosol generating article.
